(19) United States
(12) Patent Application Publication
(10) Pub. No.: US 2012/0207335 A1
(43) Pub. Date: Aug. 16, 2012

(54) PORTED MEMS MICROPHONE

(75) Inventor: Paul T. Spaanderman, Leiden (NL)

(73) Assignee: NXP B.V., Eindhoven (NL)

(21) Appl. No.: 13/027,043

(22) Filed: Feb. 14, 2011

(51) Int. Cl. H04R 11/04

(52) U.S. Cl. 381/361

(57) ABSTRACT

A microphone has first and second supports, a MEMS cartridge attached to the first support, at least part of the MEMS cartridge facing an opening in the first support, adhesive attaching the MEMS cartridge to the first support, an AMP/AD device attached to one of the supports, and a first conductor through which the MEMS cartridge electrically communicates with the AMP/AD. A second conductor is provided through which the AMP/AD electrically communicates with the external electrical contact, and a casing is located between and attached to the first and second supports. During operation, the MEMS cartridge receives an acoustic signal and generates a first electrical signal, the AMP/AD receives the first electrical signal from the MEMS cartridge, and the AMP/AD outputs to the external electrical contact a second electrical signal related to the first electrical signal.

### FIELD OF THE INVENTION

This invention relates generally to small-sized transducers, and, more specifically, to an acoustic microphone or speaker in which the acoustical-to-electrical or electrical-to-acoustical transformer (the so-called cartridge) is realized through the use of Micro Electro Mechanical Systems (“MEMS”), such as silicon MEMS technology

### BACKGROUND OF THE INVENTION

In view of the continuing miniaturization of electronic devices, e.g., hands-free communication devices, GSM devices, and hearing aids, there is an ongoing drive to develop ever-smaller components for use in such devices.

In the field of communications, for reasons of both size and performance, small microelectromechanical systems-based microphones (“MEMS microphones”) have been developed as an alternative to electret condenser microphones (“ECMs”). A MEMS microphone offers a number of advantages over an ECM, including advantages in manufacturability, production volume scalability and stability in varying environments, as non-limiting examples. It is often challenging to design an acoustically optimized MEMS microphone package because package design requirements are largely set by the mechanical interfaces of the device in which the MEMS microphone is to be used. For example, the design requirements may depend on how and where the MEMS microphone is integrated in the device. Such a microphone can be provided in a form including a MEMS-based cartridge structure, which can facilitate construction of a device using such a microphone, for example in a mobile phone or hearing aid.

MEMS cartridge-based microphones may have to be designed taking into account considerations arising from the MEMS nature of the MEMS elements of the device. By way of example only, mechanical stresses can arise in the device as a result of temperature changes, and such stresses must be tolerated if the device is to have a sufficient operating life and/or have performance which is not adversely affected by such stresses. It is therefore desirable for the microphone's design to take into account such considerations, since those considerations can significantly influence the microphone's lifespan and/or performance.

Also by way of example only, decreasing the size of a microphone can affect the microphone's acoustic volume, which in turn can affect the microphone's performance. It is therefore important, to insure adequate microphone performance, to provide the microphone with the maximum effective acoustic volume. This can be done by controlling the number of components used in the microphone, and their sizes.

Two types of basic transducers are known, top port and bottom port transducers. For reference purposes, the bottom of a transducer (a microphone or speaker) is the side where are located the electrical terminals through which the transducer is electrically connected to the electrical system of an associated device. The so-called port is the acoustic interface between the transducer and the outside world.

As follows from FIG. 3 of U.S. patent appln. publn. no. 2010/0183174, a bottom port microphone refers to a microphone having a port for acoustic entrance located at the same side as the electrical terminals of the device. As follows from FIG. 2 of U.S. patent appln. publn. no. 2010/0183174, a top port microphone refers to a microphone where the port is on the opposite side of the microphone compared to where the electrical terminals of the device are located. As noted in U.S. patent appln. publn. no. 2010/0183174, a bottom port microphone typically has good performance because the back volume beneath the MEMS cartridge is larger than the front volume above the MEMS cartridge, and so may be preferred from the viewpoint of acoustic design.

All such microphones use a substrate as a carrier for the electrical terminals and the microphone's active components. This substrate, together with the other sides of the device, each of which can made out of any suitable material, define the acoustic closed volume with a port(s) as the acoustic interface to the outside world.

In a typical bottom port MEMS microphone such as that shown in FIG. 3 of U.S. patent appln. publn. no. 2010/0183174, the MEMS cartridge is generally fitted to the substrate on which are located the device's electrical terminals, and so it is easy to connect the MEMS cartridge to any active component also fitted to the substrate. An acoustically-closed box having at least one acoustic port at the bottom side is formed by the substrate and the other portions of the enclosure.

In the bottom port arrangement, when the MEMS cartridge is placed atop the circuit board the acoustic input path of the microphone can include a hole through the circuit board supporting the MEMS cartridge. As a result, it is relatively easy to design bottom-port MEMS-based microphones, and the front-back volumes of such microphones typically have the right proportions for achieving the desired acoustic performance. In other words, the acoustic input is through a hole in the substrate, meaning this design can be realized using a straightforward substrate, together with a cover placed atop the substrate.

A typical top port MEMS microphone provides an acoustic interface (i.e., opening) at the top side of the microphone, while the possible active components and electrical terminals are located at the other, bottom side. In typical implementations of such microphones, it is therefore necessary to make compromises which affect the functional and qualitative parameters of the microphones. In current existing solutions, as with bottom port solutions, the MEMS cartridge is generally fitted to the same substrate as that having the electrical terminals. In many such designs, the position of the backplate is the same as in the bottom port implementation, and so the front and back volume parameters have swapped place in the functional transfer function. As a result, the acoustic performance of this type of microphone is worse than that of the bottom port implementation. As noted in U.S. patent appln. publn. no. 2010/0183174, a top port microphone typically has poor performance because the front volume above the MEMS cartridge is larger than the back volume behind the MEMS cartridge.

Moreover, in the microphone described in the previous paragraph, swapping the position of the backplate and the membrane will not affect device performance.

Also in contrast to a bottom port microphone, as shown in U.S. 2010/0183174, in a top port microphone there is no obstruction or membrane in front of the microphone's backplate. However, this arrangement makes the top port design more vulnerable to pollution reaching the backplate, which is undesirable, as it can cause reliability issues.

Due to cost limitations and others, the conventional implementation of a top port design is realized with no real process changes and with only two changes compared to the bottom port—unlike the bottom port microphone, the top port microphone has a hole (port or acoustic interface) in the metal portion forming the top and vertical sides of the enclosure, and the hole (port or acoustic interface) in the substrate for the bottom port, is closed. These differences can decrease microphone performance, which needs to be addressed.

MEMS microphone package configurations of top port design are disclosed in U.S. patent appln. publn. no. 2008/0175425, which employs solder balls to establish various internal electrical connections. However, this method of construction can create unwanted mechanical stresses, and may require close tolerances and additional manufacturing processes, which can increase manufacturing costs.

Various MEMS microphone package configurations of both top and bottom port design are disclosed in Feiertag, G. et al., “Flip Chip MEMS Microphone Package With Large Acoustic Reference Volume,” Procedia Engineering 5, pgs. 355-58, Elsevier Ltd. (2010), which disparages the use of wire bonding to form MEMS microphones, and proposes using flip chip technology to form MEMS microphones. Again, solder balls are used to effect various internal electrical connections, and so this can have the same problems as the teachings of the '425 publication just discussed.

In view of the foregoing considerations, the inventor considers that there is a general view that it is easier to create MEMS-based bottom port microphones than top port MEMS-based microphones with similar performance, and, as a result, on a cost basis, top ports may have lower performance than bottom port microphones.

The inventor has addressed the need for top port MEMS-based microphones and developed the present invention, which, by way of example only and not limitation, can be used in hands-free devices, GSM devices, and hearing aids.

### SUMMARY OF THE INVENTION

The present invention involves various related design implementations for top port MEMS microphone designs which may overcome at least one of the problems resulting from the aforementioned top port location issue. Such design implementations even can be applied to and improve bottom port MEMS microphone designs.

Speaking generally, the inventor has recognized that, wherever one locates the active components of a MEMS-based microphone, electrical signals are passed from the bottom side toward the top side of the product. This application proposes ways to effectuate such signal transfer that can improve functional performance and reliability.

Among the aspects of the present invention which are directed toward achieving these goals are the use of a loose end wire-bonding process, and the use of particular wire bending methods during the bonding processes.

This invention also employs, in some embodiments, blind contacting, which occurs when a free end bent wire realizes contact through the inherent spring pressure in the wire against a contacting surface, and/or through the use of conductive adhesive.

One aspect of this invention involves a microphone with a first support having an opening and an inner surface, a second support including an external electrical contact, a MEMS cartridge attached to the first support, at least a portion of the MEMS cartridge facing the opening, an adhesive located between the MEMS cartridge and the inner surface of the first support and attaching the MEMS cartridge to the first support, and an AMP/AD device attached to one of the first support and the second support. The microphone also has at least a first conductor through which the MEMS cartridge electrically communicates with the AMP/AD, at least a second conductor through which the AMP/AD electrically communicates with the external electrical contact, and a casing located between and attached to the first support and the second support. During operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

If desired, the AMP/AD can be attached to the first support.

The microphone also can have an internal contact, located at the second support, that is electrically connected to the external electrical contact, and the second conductor is in electrical communication with the internal contact.

In this microphone, the internal contact can be a portion of the external electrical contact.

The MEMS cartridge can be an acoustic sensor.

The microphone also can have an air shielding member with at least a portion located between the opening and the MEMS cartridge.

Such an air shielding member can have an interior and a volume of the interior is greater than that which would be occupied by a projection of the opening through the air shielding member.

The microphone also can include an intermediate contact located on the inner surface of the first support, and the second conductor can electrically connect the AMP/AD to the intermediate contact.

A portion of the second conductor can be attached to the internal contact, and another portion of the second conductor can be in pressing contact with the intermediate contact.

The AMP/AD can be attached to the second support and a first portion of the first conductor is attached to a one of a conductive region of the MEMS cartridge and a conductive region of the AMP/AD.

The first portion of the first conductor can be attached by at least one of wire bonding and adhering.

Another aspect of this invention is a microphone including a first support having an opening and an inner surface, a second support including an internal contact and an external contact, a MEMS cartridge attached to the first support, at least a portion of the MEMS cartridge facing the opening, and adhesive located between the MEMS cartridge and the inner surface of the first support and attaching the MEMS cartridge to the first support. Also, an AMP/AD device is attached to the second support, there is a first conductor through which the MEMS cartridge electrically communicates with the AMP/AD, and a casing is located between and attached to the first and second supports, During operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

Optionally, a first portion of the first conductor is attached to at least one of a conductive region of the MEMS cartridge and a conductive region of the internal contact.

The first portion of the first conductor can be attached by at least one of wire bonding and adhering.

The first support can have an interior cavity and a volume of the interior cavity can be greater than that which would be occupied by a projection of the opening through the member.

Another aspect of this invention is a microphone with a support having an inner surface and an external electrical contact, an AMP/AD attached to the inner surface of the support and in electrical communication with the external electrical contact, a casing attached to the support to define a microphone interior, the casing having an inner surface and an opening, and a MEMS cartridge disposed within the microphone interior so that at least a portion of the MEMS cartridge faces at least a portion of the opening and another portion of the MEMS cartridge faces the microphone interior. The microphone also includes a pair of conductors which are each at least a part of an electrical signal path between the MEMS cartridge and the AMP/AD, each of the conductors being disposed between the MEMS cartridge and the support, and adhesive is located between a portion of the inner surface of the casing and at least part of the MEMS cartridge. During operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

The MEMS cartridge can be attached to the inner surface of the casing by the adhesive.

The conductors can urge the MEMS cartridge toward the inner surface of the casing.

The support can include a pair of first casing contacts electrically connected to the AMP/AD, a second casing contact electrically connected to the external electrical contact, the pair of conductors are electrically connected to the AMP/AD through the pair of first casing contacts, and the AMP/AD can be electrically connected to the external electrical contact through the second casing contact.

Optionally, the microphone can have a member, at least a portion of which is located between the opening of the support and the MEMS cartridge.

The microphone's member can have an interior cavity and a volume of the interior cavity can be greater than that which would be occupied by a projection of the opening through the member.

### BRIEF DESCRIPTION OF THE DRAWINGS

FIG. 1 depicts, in side cross-sectional view, a microphone in accordance with a first embodiment of this invention;

FIG. 2 depicts, in side cross-sectional view, a microphone in accordance with a second embodiment of this invention;

FIG. 3 depicts, in side cross-sectional view, a microphone in accordance with a third embodiment of this invention;

FIG. 4 depicts, in side cross-sectional view, a microphone in accordance with a fourth embodiment of this invention;

FIG. 5 depicts, in side cross-sectional view, a microphone in accordance with a fifth embodiment of this invention;

FIG. 6 depicts, in side cross-sectional view, a microphone in accordance with a sixth embodiment of this invention;

FIG. 7 depicts, in side cross-sectional view, a microphone in accordance with a seventh embodiment of this invention;

FIG. 8 depicts, in side cross-sectional view, a microphone in accordance with an eighth embodiment of this invention; and

FIG. 9 depicts, in side cross-sectional view, a microphone in accordance with a ninth embodiment of this invention.

### DETAILED DESCRIPTION OF EXEMPLARY EMBODIMENTS

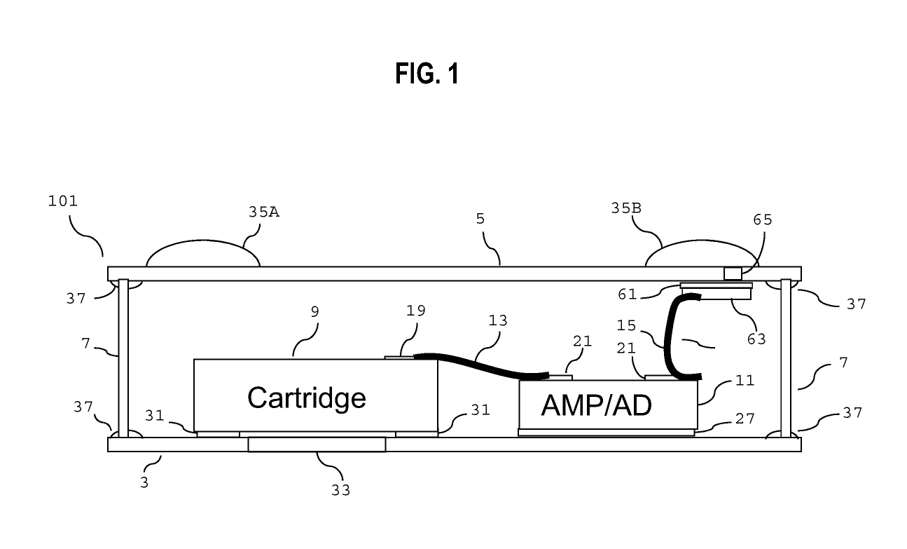

Although FIGS. 1-3 are directed to different embodiments, all of those drawings depict devices in which the active components of the microphone are located on a single circuit board.

### First Embodiment

FIG. 1 is directed to an embodiment in which all active parts are arranged at a single, top port-side, support, typically and preferably, a circuit board, and, more particularly, a printed circuit board. As explained in detail below, electrical connections to the bottom (contact) side of the device are established using bond wires. These wires are joined in such a way that when the device is assembled, these wires will create the desired electrical connections. Securement of at least some of the wires can be achieved using pressure contact and/or conductive adhesive, as described in greater detail below, while other wires can be bonded. As a result, the assembly process can be simplified.

FIG. 1 depicts the microphone 1 oriented so that the opening 33 through which acoustic signals can pass faces downward. It will be understood that such a microphone 1 could be operated in any other orientation which is desired, for example, with the opening pointing upward and the product solder pads facing downward.

Microphone 1 includes a top circuit board 3 and a bottom circuit board 5 (owing to the microphone's depicted orientation, the top circuit board 3 is shown as located beneath the bottom circuit board 5), and an enclosure 7. Enclosure 7 is preferably, although not necessarily, annular in shape when viewed from above, and other shapes such as a rectangular “collar” or frustro-conical ring could be employed. Enclosure 7 is preferably made of metal or circuit board material. Microphone 1 also includes a MEMS cartridge 9, and an amplifier/analog-to-digital converter AMP/AD 11. The top circuit board 3 has an opening 33 through which acoustic waves can enter the interior of the microphone 1, where they are converted by the microphone's components to electrical signals. Opening 33 can have any suitable shape; presently, and by way of example only and not limitation, an oval shape may be preferred, and it will be understood that any other suitable shape for the opening 33, such as a circle or rectangle, could be employed. Also, the opening 33 could at least in part be covered by or underlaid by a layer of fabric or other material to alter its acoustic and/or visual properties (not shown), and to at least reduce the likelihood of debris entering the microphone 1. For the same reasons, a piece of acoustically transparent material such as low-density foam could be put into the opening.

If desired, supports which are not circuit boards could be employed, provided such supports are configured with regard to the electrical interconnection of various microphone components (discussed below) so that they can be used in place of the circuit boards discussed herein. By way of non-limiting example, a piece of ceramic or stiff plastic could be used.

As shown in FIG. 1, bottom circuit board 5 has formed thereon outward-facing product solder pads 35A,B, an inward-facing conductive pad 61 (preferably, gold covered if a conductive wire 15 is to be joined thereto by adhesive or wire bonding), and inward facing case shielding solder 37. Outward and inward are defined with respect to the interior and exterior of the assembled microphone. As explained in further detail below, the case shielding solder 37 joins the bottom circuit board 5 to the enclosure 7, so the case shielding solder 37 is preferably arranged to be present throughout a region corresponding to the projection of the enclosure 7 onto the bottom circuit board 5 (in other words, a seal, preferably continuous, is established). By way of further non-limiting example, a suitable adhesive material such as epoxy could be used in place of the case shielding solder 37. Other attachment schemes also could be used.

MEMS cartridge 9 is attached to the top circuit board 3 by MEMS adhesive 31. AMP/AD 11 is attached to the top circuit board 3 by MEMS adhesive 27. MEMS adhesive 27, 31 joins the AMP/AD 11 and MEMS cartridge 9 to the top circuit board 3 to form a top subassembly.

It may be preferable to construct microphone 1 in part by soldering enclosure 7 to the bottom circuit board 5. This can be done by placing the enclosure 7 against the case shielding solder 37 on the bottom circuit board 5, and then heating the case shielding solder 37; when the case shielding solder 37 is heated sufficiently, it will soften and preferably liquefy about a region of the enclosure 7, creating a seal. Then, after the solder cools, the two components are joined together, so that the bottom circuit board 5 and enclosure 7 (and any other parts associated therewith) form a bottom subassembly, which can thereafter be joined to the top subassembly that includes the MEMS cartridge 9 and the AMP/AD 11. Such heating can occur in a reflow process.

Also by way of non-limiting example, the case shielding solder 37 could be heated directly by contact with a heated member (i.e., a soldering iron tip or a heated jig), by heating the enclosure 7 so that heat is transferred to the case shielding solder 37, or by heating the entire assembly in an oven (taking care not to cause thermal damage to any components in the microphone 1).

FIG. 1 also depicts the electrical connection of the upper and lower subassemblies. To effect such electrical connection, a bond wire 13 is provided which electrically connects the MEMS cartridge 9 and the AMP/AD 11. The MEMS cartridge 9 and AMP/AD 11 have bond pads 19 and 21, respectively, to which are attached portions of the bond wire 13, preferably, by wire bonding.

Microphone 1 also includes a bond wire 15 which electrically connects the AMP/AD 11 to the pad 61 of the product solder pad 35A,B. Bond wire 15 is positioned between the top and bottom subassemblies, whether before or as those subassemblies are brought together. To create the desired electrical connection, one portion of bond wire 15 is wire bonded to pad 21 on the AMP/AD 11, and another portion of the bond wire 15 preferably is either adhered or cold plated (pressure contacted) to the pad 61 for the product solder pad 35B (pad 61 can have a coating 63, which could be conductive adhesive, depending upon the attachment technique that is used).

Assembly of microphone 1 can be facilitated by mounting the MEMS cartridge 9 and AMP/AD 11 on the top circuit board 3, bonding wire 13 to the MEMS cartridge 9 and AMP/AD 11, and bonding wire 15 to the AMP/AD, forming the top subassembly. Then, the top subassembly is brought together with the bottom subassembly (as explained above, the bottom subassembly includes the enclosure 7 joined to the bottom circuit board 5.

As the two subassemblies come together, the free end of bond wire 15 approaches and then presses against pad 61, which is preferably coated with conductive adhesive (it will be appreciated that the shape and orientation of bond wire 15 are chosen so that bond wire 15 contacts the coating 63 of pad 61 as the two subassemblies come together). Preferably, a reflow process is then performed to join the metal enclosure 7 to the top circuit board 3. Bond wire 15 thereby serves to establish an electrical signal path between the top circuit board 3 and the bottom circuit board 5.

If the enclosure 7 is made of circuit board material, it may be preferable for the enclosure 7 to be rectangular in shape; since then the enclosure 7 could be fabricated by scoring an elongated piece of circuit board material at positions corresponding to the corners of the desired rectangular shape, and then folding the elongated piece of circuit board into the rectangular shape. Then, adhesive or another suitable bonding technique could be used to join together the free ends of the elongated circuit board so that it holds the rectangular shape and is suitable for acoustic enclosure.

Once assembled, microphone 1 can be joined in known fashion to the device in which it is to be used (for example, product solder pads 35A,B could be joined by wiring to other electrical components of a hearing aid).

Throughout this and the following embodiments, the use of the singular implies the plural, and vice versa; for example, more than one bond wire could be used at a given location.

### Second Embodiment

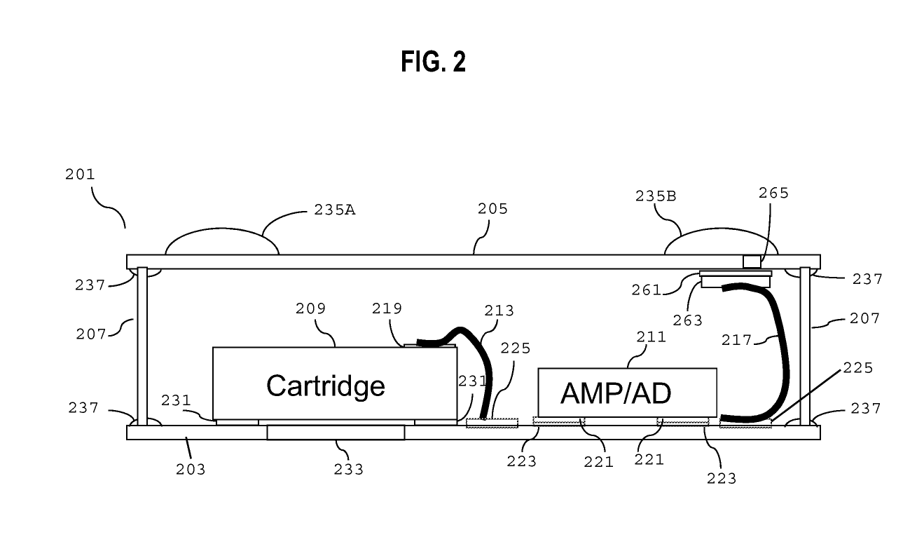

FIG. 2 is directed to an embodiment in some ways similar to that shown in FIG. 1, and differing from that first embodiment at least with regard to how certain electrical connections within the device are made. For convenience, structures shown in FIG. 2 corresponding to structures shown in FIG. 1 are correspondingly numbered, subject to the incrementation of the structure number by 200 (e.g., microphone 1 shown in FIG. 1 has a corresponding microphone 201 shown in FIG. 2. To the extent the structures shown in FIG. 2 correspond to structures shown in FIG. 1 and discussed above, those structures only will be discussed insofar as they are relevant to aspects of this embodiment.

FIG. 2 depicts an assembled microphone 201 which is a variant of the FIG. 1 embodiment, oriented so that the opening 233 faces downward (again, this is a top port microphone). It will be understood that such a microphone 201 could be operated in any orientation as is desired.

A MEMS cartridge 209 is attached to the top circuit board 203 by MEMS adhesive 231.

The top circuit board 203 includes case shielding solder 237 and for the attachment of electrical components to be described later, conductive pads 223, which can include either conductive adhesive or solder, depending upon the attachment technique that is to be used. The top circuit board 203 also includes pads 225. At least some of pads 223 and 225 can be in electrical communication in known fashion so as to allow electrical communication between various components of microphone 201 (for example, through the internal structure of the circuit board 203).

One portion of a bond wire 213 is joined to pad 225, preferably, either by conductive adhesive or wire bonding (if wire bonding is used, that pad 225 can be gold plated). Bond wire 213 is shaped so that another portion of the wire presses against and establishes electrical contact with pad 219 of MEMS cartridge 209.

The AMP/AD 211, which includes contacts 221 through which electrical signals can pass, is mounted to the top circuit board 203 by placing those contacts 221 against the conductive pads 223 of the top circuit board 203 (if attachment is to be effected by soldering, heating thereafter takes place).

Top circuit board 203 also includes a pad 225 to which is attached a portion of bond wire 217. Such attachment can be made either by bonding (in which case the pad 225 can be gold plated) or the use of conductive adhesive. Another portion of bond wire 217 is attached to a pad 261 on the bottom circuit board 205, possibly by adhesive (adhesive is shown as 263). Bond wire 217 thereby serves to establish an electrical signal path between the top circuit board 203 and the bottom circuit board 205.

Electrical communication between the MEMS cartridge 209 and AMP/AD 211 can take place by signals passing from pad 219 of the MEMS cartridge 209 through wire 213, to pad 225 into the internal electrical structure of top circuit board 203, and though associated pad 223 to the AMP/AD 211, and from there through pad 223 via the internal electrical structure of top circuit board 203 to pad 225. The signal then passes from pad 225 through wire 217 to pad 261 (coated with coating 263), which is electrically connected to product solder pad 235B.

In a manner similar to the previous embodiment, microphone 201 can be assembled by joining the MEMS cartridge 209, AMP/AD 211, and bond wires 213 and 217 to the top circuit board to form a top subassembly, and by joining the enclosure 207 to the bottom circuit board 205 to form the bottom subassembly. Then, the subassemblies are brought together, and a reflow process is performed, to complete assembly (as in the previous embodiment, the size and shape of wire 217 are chosen so that it will be able to connect electrically to pad 261). Once assembled, the microphone 201 can be re-oriented so that the opening 233 faces in the desired direction and product solder pads 235A,B can be joined to the device in which the microphone is to be used.

### Third Embodiment

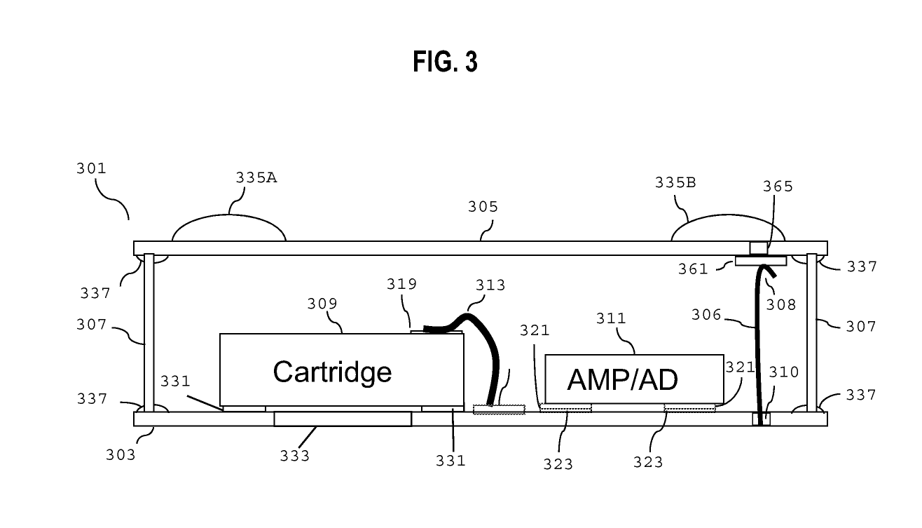

Structures shown in FIG. 3 corresponding to structures shown in FIG. 1 are correspondingly numbered subject to the incrementation of the structure number by 300 (e.g., microphone 1 shown in FIG. 1 has a corresponding microphone 301 shown in FIG. 3). To the extent the structures shown in FIG. 3 correspond to structures shown in other embodiments of the invention and discussed above, those structures only will be discussed insofar as they are relevant to aspects of this embodiment.

FIG. 3 depict an embodiment which is in at least some ways similar to the second embodiment, and which differs with regard to the electrical signal path between the top and bottom circuit board. More specifically, this embodiment omits the bond wire 217 depicted in FIG. 2. Instead, as shown in FIG. 3, a connecting wire 306 is provided. One end of the connecting wire 306 is embedded in a conductive adhesive region 310 present in the top circuit board 303 and that connecting wire is in electrical communication with electrical structure of the top circuit board 303. As shown in FIG. 3, the connecting wire 306 is dimensioned and arranged so that a bent portion 308 contacts a pad 361 on the bottom circuit board 305 (that pad 361 can be in electrical communication with product solder pad 335B via a connecting portion 365 that extends through bottom circuit board 305, or other suitable structure such as internal electrical structure of the circuit board). The bent end 308 of connecting wire 306 can be arranged so that, when the microphone 301 is assembled by bringing together the top subassembly (having bottom circuit board 303, MEMS cartridge 309 and AMP/AD 311) and bottom subassembly (having the bottom circuit board 305 and enclosure 307), that bent end 308 is pressed into secure contact with pad 361 for electrical communication therebetween. Alternatively, that bent end 308 could be welded or adhered to the pad 361 (such welding/adhering is not shown) As a result, contact wire 306 electrically connects the top and bottom circuit boards 303, 305. Thus, this structure can be formed in two ways—either wire 306 is first wire bonded to pad 361 before it is adhered, or the wire 361 is first adhered to board 303 and bent portion 308 then presses into the adhesive or is pressed against pad 361.

Also alternatively (not depicted), the orientation of the connecting wire 306 could be reversed so that the connecting wire 306 is secured to the bottom circuit board 303, and is press-contacted to the top circuit board. In this configuration, one end of the connecting wire 306 is embedded in a portion 365 of the product solder pad 335B which extends through the bottom circuit board 303. The bent end 308 of the connecting wire then would press against (or be welded or adhered to) a contact (not shown) formed inward of the solder region 310 depicted in FIG. 3.

Among the benefits of this configuration is that assembly of the microphone 301 can be simplified through use of the connecting wire 306, which is attached to either the upper or lower subassembly of the microphone 301 before those subassemblies are brought together. Since the bent end 308 of the connecting wire 306 can be press-contacted to the associated pad 361, it is not necessary to perform adhering, bonding or soldering procedures to join those parts (although, as noted above, those processes could be performed, to improve the connection). The assembly process is thereby improved.

Microphone 301 can be assembled by joining the MEMS cartridge 309, AMP/AD 311, and bond wires 313 and 306 to the top circuit board to form a top subassembly, and by joining the enclosure 307 to the bottom circuit board 305 to form the bottom subassembly. Then, the subassemblies are brought together, and a reflow process or other heating process is performed, to complete assembly (the size and shape of wire 306 are chosen so that it will be able to connect electrically to pad 361). Once assembled, the microphone 301 can be re-oriented so that the opening 333 faces in the desired direction and product solder pads 335A,B can be joined to the device in which the microphone 301 is to be used.

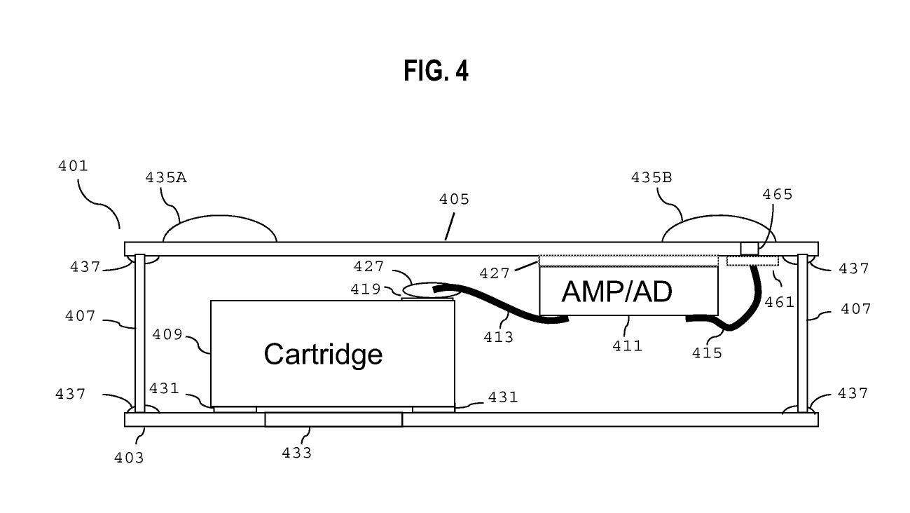

Although the following three embodiments depicted in FIGS. 4-6 are different, all of those drawings illustrate devices in which the active components of the microphone are located on a single circuit board.

### Fourth Embodiment

Structures shown in FIG. 4 corresponding to structures shown in FIG. 1 are correspondingly numbered subject to the incrementation of the structure number by 400 (e.g., microphone 1 shown in FIG. 1 has a corresponding microphone 401 shown in FIG. 4). To the extent the structures shown in FIG. 4 correspond to structures shown in other embodiments of the invention and discussed above, those structures only will be discussed insofar as they are relevant to aspects of this embodiment.

FIG. 4 is drawn to an embodiment of a microphone 401 in which the MEMS cartridge 409 is mounted to the top circuit board 403. The amplifier/analog-to-digital converter AMP/AD 411 is mounted to the facing (inner) side of the bottom circuit board 405. FIG. 4 shows the assembled microphone 401 with an opening 433 facing downward and through which acoustic signals can pass once the device is assembled.

The MEMS cartridge 409 can be mounted to the top circuit board 403 in the same manner as has been described for the previous embodiments, using a MEMS adhesive underfill 431. The MEMS cartridge 409 and top circuit board 403 thereby become part of the top subassembly.

As also depicted in FIG. 4, the bottom subassembly can be formed by mounting AMP/AD 411 to the inner side of bottom circuit board 405 using an adhesive underfill 427 to hold the AMP/AD 411 in place. The bottom circuit board 405 has outwardly-facing product solder pads 435A,B, and a portion 465 of one product solder pad 435B can extend through the bottom circuit board 405 and be in electrical connection with a pad 461. Bond wire 415 electrically connects pad 461 to AMP/AD 411, preferably, by wire bonding (AMP/AD 11 can have contact pads (not shown) for electrical connection thereto). Another bond wire 413, shaped and positioned for later electrical connection to MEMS cartridge 409 when the microphone is assembled, is also attached to the AMP/AD 411, preferably, but not necessarily, by wire bonding. An enclosure 407 is joined to the bottom circuit board 405 by case shielding solder, as previously discussed in connection with other embodiments.

The top and bottom subassemblies are then brought together to form the microphone. In doing so, conductive adhesive 427 preferably is placed on the contact 419 of MEMS cartridge 409, so that as the top and bottom subassemblies are brought together, a portion at the free end of the bond wire 413 (which is part of the bottom subassembly) meets the conductive adhesive 427 (which can be on the AMP/AD 411, a part of the top subassembly), establishing a secure electrical connection between the MEMS cartridge 409 and the AMP/AD 411. Case shielding solder 437 on the top circuit board 403 is provided to abut the enclosure 407.

In an alternative arrangement, during fabrication of the top subassembly, the bond wire 413 could be bonded to the contact 419 of MEMS cartridge 409. Then, when the top and bottom subassemblies are brought together, a portion of the free end of the bond wire 413 would oppose and contact the AMP/AD 411, conductive adhesive 427 preferably being used to secure that free end to the AMP/AD 411.

Once the top and bottom subassemblies are brought together, the enclosure 407 abuts the case shielding solder 437 on the top circuit board 403 (previously the enclosure 407 was joined to the bottom circuit board 405 by case shielding solder 437). A reflow process or other heating process is then performed, causing the case shielding solder 437 to join the enclosure 407 to the top circuit board.

The assembled microphone 401 then can be re-oriented as desired, for example, so that the opening 433 faces upward, and product solder pads 435A,B can be connected to other portions of the device.

### Fifth Embodiment

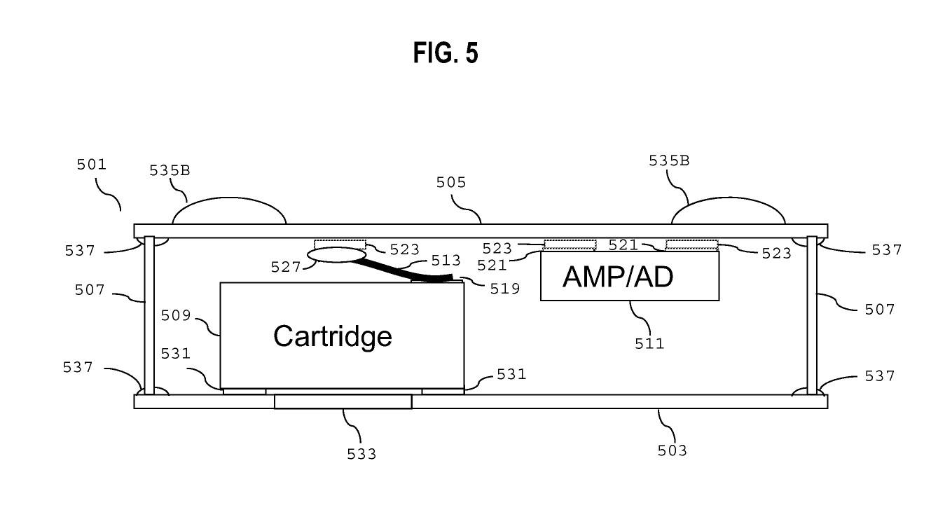

This embodiment, as shown in FIG. 5, employs a known flip-chip process to connect the AMP/AD 511 to the bottom circuit board 505. Structures shown in FIG. 5 corresponding to structures shown in FIG. 1 are correspondingly numbered subject to the incrementation of the structure number by 500 (e.g., microphone 1 shown in FIG. 1 has a corresponding microphone 501 shown in FIG. 5). To the extent the structures shown in FIG. 5 correspond to structures shown in other embodiments of the invention and discussed above, those structures only will be discussed insofar as they are relevant to aspects of this embodiment.

In this embodiment, the top subassembly is formed by joining MEMS cartridge 509 (which includes a pad 519) to the top circuit board 503 using adhesive 531. Bond wire 513 is connected to the pad 519 of the MEMS cartridge 509, preferably, by wire bonding (one end of the bond wire 513 remains free), but any other suitable attachment technique could be employed. The top circuit board 503 has an opening 533 through which acoustic signals can pass once the microphone 501 is assembled, as well as case shielding solder 537.

One of the components of the bottom subassembly is bottom circuit board 505. Bottom circuit board 505 includes product solder pads 535A,B and a number of electrical pads 523, at least some of which can be electrically interconnected through the inner layers of the bottom circuit board 505 (any other alternative connection scheme, such as surface traces on the circuit board, also could be used). One of the electrical pads 523 is electrically connected to one of the product solder pads 535, preferably through the internal structure of the circuit board.

The bottom subassembly is formed by joining enclosure 507 to the bottom circuit board 505 using case shielding solder 537. Also, the AMP/AD 511 is joined to the bottom circuit board 505 using a known flip-chip process so that the contacts 521 of the AMP/AD 511 are joined to the corresponding pads 523 of the bottom circuit board 505.

The top and bottom subassemblies are then brought together. As shown in FIG. 5, the free end of the bond wire 513 is positioned so that, as the top and bottom subassemblies approach, that free end opposes one of the electrical pads 523 of the bottom circuit board 505 (again, that electrical pad 523 can be electrically connected to one or more of the other electrical pads 523 through the internal structure of the bottom circuit board). Conductive adhesive 527 preferably is used to join the free end of the bond wire 513 to the opposing electrical pad 523.

In an alternative arrangement, during fabrication of the bottom subassembly, the bond wire 513 could be bonded to the contact 523 of the bottom circuit board 505. Then, when the top and bottom subassemblies are brought together, a portion of the free end of the bond wire 513 would oppose and then contact the pad 519 of the MEMS cartridge 509, with conductive adhesive 527 now preferably being used to secure that portion of the free end of the bond wire 513 to the MEMS cartridge 509.

Once the top and bottom subassemblies are brought together, the exposed edge of the enclosure 507 abuts the case shielding solder 537 on the top circuit board 503 (the enclosure 507 was previously joined to the bottom circuit board 505 by case shielding solder 537 during formation of the bottom subassembly). A reflow process or other suitable heating process is then performed, causing the case shielding solder 537 to join the enclosure 507 to the top circuit board 503.

The assembled microphone 501 then can be re-oriented as desired, for example, so that the opening 533 faces upward, and product solder pads 535A,B can be connected to other portions of the device.

### Sixth Embodiment

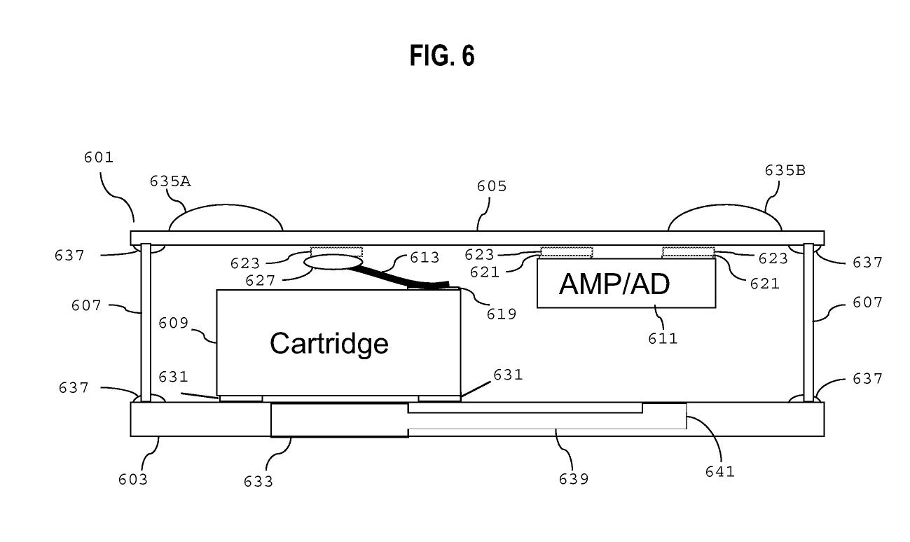

FIG. 6 depicts what can be considered a variation of the fifth embodiment. Structures shown in FIG. 6 corresponding to structures shown in FIG. 1 are correspondingly numbered subject to the incrementation of the structure number by 600 (e.g., microphone 1 shown in FIG. 1 has a corresponding microphone 601 shown in FIG. 6). To the extent the structures shown in FIG. 6 correspond to structures shown in other embodiments of the invention and discussed above, those structures only will be discussed insofar as they are relevant to aspects of this embodiment.

Microphone 601 includes a top circuit board 603 having an opening 633 through which acoustic signals can pass. To form a tunable additional front volume for the assembled microphone 601 where coupling region 641 has no opening to the back volume, the top circuit board 603 includes an internal cavity 639 which communicates with opening 633. This cavity 639 can include a coupling region 641 which serves to couple cavity 639 to the back volume of microphone 601 in order to alter the microphone's frequency response (also, the shape of the cavity 639 can be chosen for its acoustic effect on the microphone 601). If desired, more than one cavity could be provided. Also, the cavity could be isolated from the opening 633, if desired. Also, cavity 639 could be filled with material having properties that desirably modify the acoustic response of the microphone. In case at coupling region 641 the additional volume is connected with the back volume of the microphone, so when coupling region 641 has been opened to the back volume an acoustic filter can be created to influence the adjust the microphones frequency curve as desired.

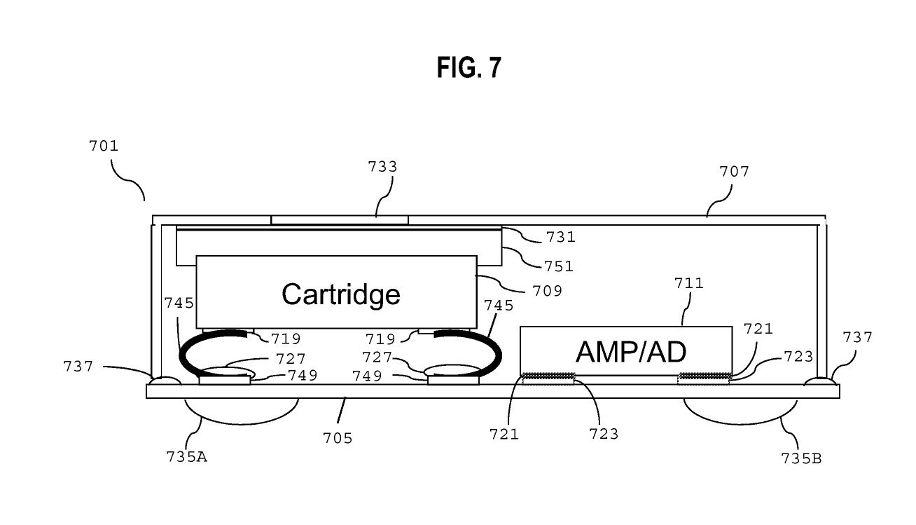

While the following three embodiments depicted in FIGS. 7-9 are different, all of those drawings illustrate devices in which the MEMS cartridge is connected to the side where it does not have its acoustic input port.

### Seventh Embodiment

Structures shown in FIG. 7 corresponding to structures shown in FIG. 1 are correspondingly numbered subject to the incrementation of the structure number by 700 (e.g., microphone 1 shown in FIG. 1 has a corresponding microphone 701 shown in FIG. 7). To the extent the structures shown in FIG. 7 correspond to structures shown in other embodiments of the invention and discussed above, those structures only will be discussed insofar as they are relevant to aspects of this embodiment.

In the embodiment depicted in FIG. 7, the bottom subassembly is formed by positioning the MEMS cartridge 709 and AMS/AD 711 on the bottom circuit board 705 as part of the bottom subassembly. As shown in FIG. 7, bottom circuit board 705 has on its outer surface product solder pads 735A,B, case shielding solder 737, and both MEMS cartridge contacts 749 and AMP/AD contacts 723. At least one AMP/AD contact 723 is in electrical connection with a product solder pad 735B. The MEMS cartridge contacts 749 and AMP/AD contacts 723 can be electrically connected to each other as desired through internal structure of the bottom circuit board 705 (not shown) or, if preferred, by other connective schemes such as surface traces on the bottom circuit board 705.

The AMP/AD 711, which includes contacts 721, can be joined to the bottom circuit board 705 by use of conductive adhesive; as a result, the contacts 721 of the AMP/AD 711 are joined to the corresponding AMP/AD contacts 723 of the bottom circuit board 705 and the AMP/AD is secured in place.

The MEMS cartridge 709 is attached to the bottom circuit board 705 as follows. Portions of “C”-shaped bond wires 745 are wire bonded to pads 719 on the bottom of the MEMS cartridge 709 (other attachment techniques also can be used). Other portions of those “C”-shaped bond wires 745 are joined to MEMS cartridge contacts 749 using conductive adhesive 727 (other attachment techniques also can be used). For reasons to be explained hereafter, the “C”-shaped bond wires are “low stress,” meaning they are compliant in nature.

During formation of the upper subassembly, an air shielding ring 751 is attached to the inner surface of a casing 707 by adhesive 731. Air shielding ring 751 includes an open internal region correspondingly generally in size and shape to an opening 733 in the casing 707. Air shielding ring 751 is preferably made from a compliant material having suitable acoustic properties for use in the microphone. Casing 707 includes an opening 733 through which acoustic signals can pass once the microphone 701 is assembled, and can have the shape of an open-ended cylinder (other shapes such as an open-ended box could be used as well). Preferably, casing 707 is metal, but any other suitable material could be used.

Microphone 701 is assembled by bringing the upper and lower subassemblies together so that at least a portion of the exposed edge of casing 707 meets the case shielding solder, and the a portion of the upper surface of MEMS cartridge 709 contacts at least a portion of the lower surface of the air shielding ring 751. The compliance of the air shielding ring 751 helps it to securely abut the MEMS cartridge 709 and so help to define an acoustic signal path. Also, the size and shape of the “C”-shaped bond wires 745 are chosen taking into account the thickness of the MEMS cartridge 709 and the thickness of the air shielding ring 751 so that, when the upper and lower subassemblies are joined together and the portions of the air shielding ring and MEMS cartridge 709 meet, the “C”-shaped bond wires 745 are deformed without applying substantial force to urge the MEMS cartridge 709 toward the air shielding ring 751. However, if desired, the “C”-shaped wires could be designed so that force is generated in order to press together the air shielding ring 751 (which is compliant) and the MEMS cartridge, and so helps to establish a good acoustic seal therebetween. The case shielding solder is liquefied to join the casing 707 to the bottom circuit board 705 as previously described.

Among the benefits of this embodiment is that, owing to the compliance of the “C”-shaped bond wires 745 and air shielding ring 751, it can accommodate variations in the thickness or position of the MEMS cartridge 709 relative to the casing 707, as well as variations in the thickness of the bottom circuit board 705 and/or the casing. This configuration also may be beneficial because the compliance of the “C”-shaped bond wires 745 and air shielding ring 751 can help to isolate the MEMS cartridge 709 from vibrations and shock.

### Eighth Embodiment

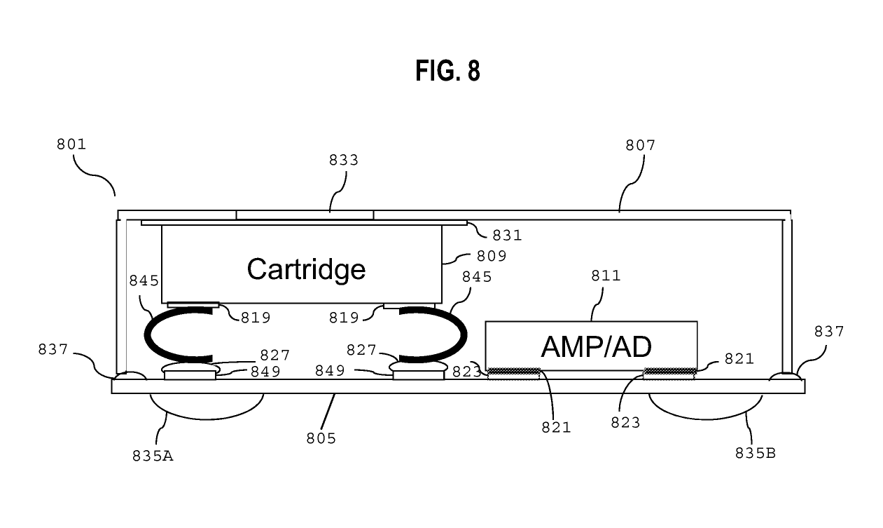

Structures shown in FIG. 8 corresponding to structures shown in FIG. 1 are correspondingly numbered subject to the incrementation of the structure number by 800 (e.g., microphone 1 shown in FIG. 1 has a corresponding microphone 801 shown in FIG. 8). To the extent the structures shown in FIG. 8 correspond to structures shown in other embodiments of the invention and discussed above, those structures only will be discussed insofar as they are relevant to aspects of this embodiment.

The eighth embodiment is a variation of the seventh embodiment. For conciseness, attention will be paid to the specific differences therebetween.

As shown in FIG. 8, AMP/AD 811 is joined to bottom circuit board 805 in the same manner as in the seventh embodiment, and together those parts form the bottom subassembly.

To form the top subassembly, “C”-shaped bond wires 845 are joined to the pads 819 on the bottom of MEMS cartridge 809. These “C”-shaped bond wires 845 are not low-stress, meaning they are relatively stiff and non-compliant. The MEMS cartridge 809 is joined to the casing 807 by adhesive 831 located between the top surface of the MEMS cartridge 809 and the inner surface of the casing 807.

To assemble the microphone 801, the upper and lower subassemblies are brought together so that portions of the “C”-shaped wires 845 press against MEMS cartridge contacts 849 on the bottom circuit board 805. Conductive adhesive 827 is used to secure the “C”-shaped wires 845 to those MEMS cartridge contacts 849 (if desired, the adhesive could be omitted, and/or other suitable attachments techniques also could be used). Casing 807 can be joined to bottom circuit board 805 by softening or liquefying case shielding solder 837 in the same manner as the seventh embodiment.

The size, shape and stiffness of the “C”-shaped bond wires 845 can be chosen to insure a good physical and electrical connection between the MEMS cartridge 809 and various other components of microphone 801.

### Ninth Embodiment

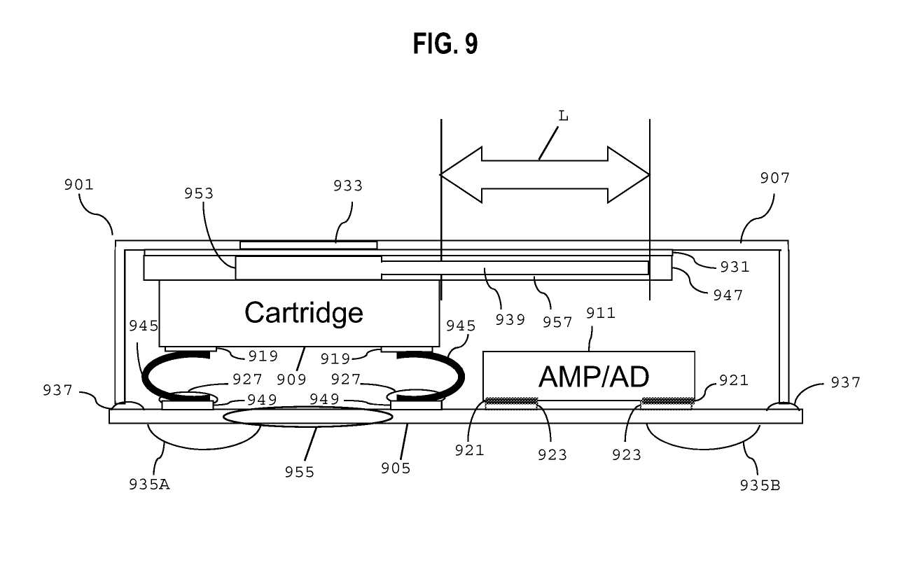

Structures shown in FIG. 9 corresponding to structures shown in FIG. 1 are correspondingly numbered subject to the incrementation of the structure number by 900 (e.g., microphone 1 shown in FIG. 1 has a corresponding microphone 901 shown in FIG. 9). To the extent the structures shown in FIG. 9 correspond to structures shown in other embodiments of the invention and discussed above, those structures only will be discussed insofar as they are relevant to aspects of this embodiment.

The ninth embodiment incorporates aspects of both the sixth and seventh embodiments. Speaking generally, the ninth embodiment provides a microphone 901 which, where the coupling region has no opening to the back volume, includes a tunable additional front volume and a tunable additional back volume. The additional front volume can, optionally, serve as a mechanical acoustical filter, to improve performance of the microphone 901.

Optionally, the back volume of microphone 901 can be tuned by selectively removing a portion of the bottom circuit board 905 opposing the MEMS cartridge 909; in FIG. 9, this region would be located within the oval area 955. Removal could be effected by any suitable manufacturing technique, for example, by precision milling or etching. Alternatively, the bottom circuit board could be fabricated with a reduced-thickness area in the desired region. Conversely, material (not shown) could be added to the inner surface of the circuit board 905. This removal or addition of material enables the designer to vary the back volume and thereby change the acoustic property of microphone 901 as desired.

Another way to tune the back volume of the microphone 901 is by back lapping of the IC die which is part of the AMP/AD 911 (not shown) so as to remove some of the die material, and thereby increase the back volume. As well, some of the outside of the MEMS cartridge could be removed, again, to tune the back volume.

As shown in FIG. 9 and described below, MEMS cartridge 909 and AMP/AD 911 are joined to bottom circuit board 905 in substantially the same manner as in the seventh embodiment. Together these parts form the bottom subassembly of microphone 901. This embodiment also includes an air shielding member 947 with an internal cavity 939 which allows the front volume of the microphone 901 to be tuned, as also described below.

More specifically, MEMS cartridge 909 is joined to the bottom circuit board 905, which has on its outer surface product solder pads 935, case shielding solder 937, and both MEMS cartridge contacts 949 and AMP/AD contacts 923. At least one AMP/AD contact 923 is in electrical connection with a product solder pad 935. The MEMS cartridge contacts 949 and AMP/AD contacts 923 can be electrically connected to each other as necessary through internal structure of the bottom circuit board 905 (not shown), or by any other suitable technique, such as conductive surface traces.

The AMP/AD 911, which includes contacts 921, can be joined to the bottom circuit board 905 by use of adhesive; as a result, the contacts 921 of the AMP/AD 911 are joined to the corresponding AMP/AD contacts 923 of the bottom circuit board 905.

The MEMS cartridge 909 is attached to the bottom circuit board 905 as follows. Portions of “C”-shaped bond wires 945 are wire bonded to pads 919 on the bottom of the MEMS cartridge 909. Other portions of those “C”-shaped bond wires 945 are joined to MEMS cartridge contacts 949 of the bottom circuit board 905 using conductive adhesive 927 (other attachment techniques also can be used). The “C”-shaped bond wires 945 can be either “low stress” as described above, or not, as desired.

During formation of the upper subassembly, air shielding member 947 is attached to the inner surface of casing 907 by adhesive 931. Casing 907 includes an opening 933 through which acoustic signals can pass once the microphone 901 is assembled, and the casing 907 can have the shape of an open-ended cylinder (other shapes such as an open-ended box could be used as well). Air shielding member 947 is preferably made from a compliant material having suitable acoustic properties for use in the microphone 901. Preferably, casing 907 is metal, but any suitable material could be used.

A passage 953 in air shielding member 947 allows acoustic signals entering opening 933 to reach MEMS cartridge 909. The air shielding member 947 includes an elongated section 957 having an internal cavity 939 which communicates with the passage 953, and thereby increases the front volume of the microphone. By varying the dimensions of the internal cavity 939 the front volume can be changed, so that the microphone can be “tuned” as desired. The internal cavity 939 also could be at least partially filled with material desirably affecting the acoustic properties of microphone 901.

Microphone 901 is assembled by bringing together the upper subassembly having the casing 907 and air shielding member 947 and the lower subassembly having the MEMS cartridge 909 and AMP/AD 911. The case shielding solder 937 is liquefied or at least softened to join the casing 907 and the bottom circuit board 905. Conductive adhesive 927 can be used to bond the “C”-shaped bond wires 945 to the contacts 949. The abutting “C”-shaped bond wires 945, MEMS cartridge 909, and air shielding member 947 are dimensioned so that, in the assembled microphone 901, undesirable levels of force are not generated in any of those components.

Optionally, the air shielding member 947 can be connected with the back volume of the microphone via an opening (not shown), so when air shielding member 947 communicates with the coupling back volume, an acoustic filter can be created to influence the adjust the microphones frequency curve as desired.

This embodiment therefore allows the designer greater tuning freedom.

It will be appreciated that either one or both of the tunable front and back volumes could be employed in a microphone.

It will be understood that instead of using conductive adhesive as outlined above with reference to various embodiments, secure electrical contact also can be achieved by pressure contacting the wire to the associated contact.

Various exemplary embodiments are described in reference to specific illustrative examples. The illustrative examples are selected to assist a person of ordinary skill in the art to form a clear understanding of, and to practice the various embodiments. However, the scope of systems, structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

To the extent positional designations such as top, bottom, upper, lower have been used in describing this invention, it will be appreciated that those designations are given with reference to the corresponding drawings, and that if the orientation of the device changes during manufacturing or operation, other positional relationships may apply instead. As described above, those positional relationships are described for clarity, not limitation.

Insofar as this disclosure may have referred to a pad, contact or wire in the singular, it will be understood that multiple pads, contacts or wires could be used so as to create multiple signal paths (for example, serial vs. parallel signal paths), and so the use of the singular implies the plural, unless stated otherwise. Likewise, the use of the plural implies the singular, unless stated otherwise.

Insofar as the term “wire” is used herein, the invention is not limited to the use of wires, and any suitable conductive member (“conductor”) is contemplated and could be employed.

Insofar as this invention has been described in connection with MEMS cartridge microphones, it will be appreciated that aspects of the invention could be employed with other types of devices, for example, ultrasonic detectors, subsonic detectors, and electromagnetic radiation detectors (including infrared, visible, and ultraviolet light detectors). Still other examples of devices which could employ this invention are loudspeakers (subsonic, audible sound and ultrasonic), and electromagnetic radiation sources (such as those for infrared light, visible light and/or ultraviolet light).

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of various elements may be exaggerated and not drawn to a particular scale. It is intended that this invention encompasses inconsequential variations in the relevant tolerances and properties of components and modes of operation thereof. Imperfect practice of the invention is intended to be covered.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

What is claimed is:

1. A microphone, comprising:
a first support having an opening and an inner surface;
a second support including an external electrical contact;
a MEMS cartridge attached to the first support, at least a portion of the MEMS cartridge facing the opening;
an adhesive located between the MEMS cartridge and the inner surface of the first support and attaching the MEMS cartridge to the first support;
an AMP/AD device attached to one of the first support and the second support;
at least a first conductor through which the MEMS cartridge electrically communicates with the AMP/AD;
at least a second conductor through which the AMP/AD electrically communicates with the external electrical contact; and
a casing located between and attached to the first support and the second support,
wherein, during operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

2. A microphone according to claim 1, further comprising:
an internal contact, located at the second support, that is electrically connected to the external electrical contact, and the second conductor is in electrical communication with the internal contact.

3. A microphone according to claim 2, wherein the internal contact is a portion of the external electrical contact.

4. A microphone according to claim 1, wherein the MEMS cartridge is an acoustic sensor.

5. A microphone according to claim 1, further comprising an air shielding member having at least a portion located between the opening and the MEMS cartridge.

6. A microphone according to claim 5, wherein the air shielding member has an interior and a volume of the interior is greater than that which would be occupied by a projection of the opening through the air shielding member, and, optionally, the interior communicates with an interior volume of the microphone through an opening.

7. A microphone according to claim 1, further comprising:
an intermediate contact located on the inner surface of the first support, and
wherein the second conductor electrically connects the AMP/AD to the intermediate contact.

8. A microphone according to claim 7, wherein a portion of the second conductor is attached to the internal contact, and another portion of the second conductor is in pressing contact with the intermediate contact.

9. A microphone according to claim 1, wherein the AMP/AD is attached to the second support and a first portion of the first conductor is attached to a one of a conductive region of the MEMS cartridge and a conductive region of the AMP/AD.

10. A microphone according to claim 1, wherein the first portion of the first conductor is attached by at least one of wire bonding and adhering.

11. A microphone, comprising:
a first support having an opening and an inner surface;
a second support including an internal contact and an external contact;
a MEMS cartridge attached to the first support, at least a portion of the MEMS cartridge facing the opening;
an adhesive located between the MEMS cartridge and the inner surface of the first support and attaching the MEMS cartridge to the first support;
an AMP/AD device attached to the second support;
a first conductor through which the MEMS cartridge electrically communicates with the AMP/AD;
a casing located between and attached to the first support and the second support,
wherein, during operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

12. A microphone according to claim 11, wherein a first portion of the first conductor is attached to at least one of a conductive region of the MEMS cartridge and a conductive region of the internal contact.

13. A microphone according to claim 12, wherein the first portion of the first conductor is attached by at least one of wire bonding and adhering.

14. A microphone according to claim 11, wherein the first support has an interior cavity and a volume of the interior cavity is greater than that which would be occupied by a projection of the opening through the member.

15. A microphone, comprising:
a support having an inner surface and an external electrical contact;
an AMP/AD attached to the inner surface of the support and in electrical communication with the external electrical contact;
a casing attached to the support to define a microphone interior, the casing having an inner surface and an opening,
a MEMS cartridge disposed within the microphone interior so that at least a portion of the MEMS cartridge faces at least a portion of the opening and another portion of the MEMS cartridge faces the microphone interior;
a pair of conductors which are each at least a part of an electrical signal path between the MEMS cartridge and the AMP/AD, each of the conductors being disposed between the MEMS cartridge and the support; and
an adhesive located between a portion of the inner surface of the casing and at least part of the MEMS cartridge,
wherein, during operation, the MEMS cartridge receives an acoustic signal and, as a result, generates a first electrical signal, the AMP/AD receives the first electrical signal from the MEMS cartridge, and the AMP/AD outputs to the external electrical contact a second electrical signal related to the first electrical signal.

16. A microphone according to claim 15, wherein the MEMS cartridge is attached to the inner surface of the casing by the adhesive.

17. A microphone according to claim 15, wherein the conductors urge the MEMS cartridge toward the inner surface of the casing.

18. A microphone according to claim 15, wherein the support includes a pair of first casing contacts electrically connected to the AMP/AD, a second casing contact electrically connected to the external electrical contact, the pair of conductors are electrically connected to the AMP/AD through the pair of first casing contacts, and the AMP/AD is electrically connected to the external electrical contact through the second casing contact.

19. A microphone according to claim 15, further comprising:
a member, at least a portion of which is located between the opening of the support and the MEMS cartridge.

20. A microphone according to claim 19, wherein the member has an interior cavity and a volume of the interior cavity is greater than that which would be occupied by a projection of the opening through the member, and, optionally, the interior cavity communicates with an interior volume of the microphone through an opening.
